(19) United States
(12) Patent Application Publication
(10) Pub. No.: US 2025/0281887 A1
(43) Pub. Date: Sep. 11, 2025

(54) PARRELLEL TUBULAR AERATOR

(71) Applicants: Christopher S. Keever, Peachtree City, GA (US); Jared Hollindrake, Cottonwood Heights, UT (US)

(72) Inventors: Christopher S. Keever, Peachtree City, GA (US); Jared Hollindrake, Cottonwood Heights, UT (US)

(21) Appl. No.: 19/067,854

(22) Filed: Mar. 1, 2025

Related U.S. Application Data
(60) Provisional application No. 63/561,352, filed on Mar. 5, 2024.

(51) Int. Cl. B01F 23/231

(52) U.S. Cl. CPC B01F 23/231

(57) ABSTRACT

Methods, systems, and apparatuses to create a vortex motion between in parallel aerators air bubble flows in water to break up the Fats, Oils, and Grease, increase mixing of the body of water, and reduce the concentration of hydrogen sulfide in the water.

### CROSS REFERENCE TO RELATED APPLICATION

This application claims priority to U.S. Provisional Application No. 63/561,352 filed Mar. 5, 2024, which is incorporated herein by reference in its entirety.

### BACKGROUND OF THE INVENTION

The presence of fats, oils, and grease (FOG) in sewage pump stations presents a significant operational challenge. When these substances enter the wastewater system, they can solidify and accumulate, leading to blockages in pipes and pumps. This accumulation can cause reduced flow rates, increased pump wear, and increased frequency of maintenance issues, which ultimately results in higher operational costs. Furthermore, FOG can interfere with the efficiency of sewage treatment processes by forming scum layers on treatment ponds or tanks, leading to inefficiencies in waste breakdown and potential environmental contamination. In addition, hydrogen sulfide causes additional issues. Hydrogen sulfide (H₂S) is corrosive and can damage equipment, especially to metals such as steel, iron, and other alloys commonly used in pumps, pipes, and other sump equipment. Over time, this corrosion can lead to failure of critical components, requiring frequent repairs or replacements. Furthermore, the buildup of hydrogen sulfide in the sump can cause a reduction in pump efficiency. Corrosion and scaling can affect the pump's moving parts, such as impellers, seals, and bearings, causing them to become less effective over time. This could result in higher energy consumption and decreased pump performance. Also, the distinctive “rotten egg” smell of hydrogen sulfide can cause discomfort and irritation to personnel working in or around the sump. In high concentrations, hydrogen sulfide can be dangerous to animals and humans. As a result, managing FOG and hydrogen sulfide is a critical concern for maintaining the functionality and sustainability of sewage pump stations.

### BRIEF SUMMARY OF THE INVENTION

Methods and apparatuses are disclosed to reduce operational issues resulting from FOG (Fats, Oils, & Grease). The apparatus is a submersible pump station aerator and mixer. It is designed to be lowered below the surface towards the bottom of a sewage pump station sump. The apparatus will typically be constructed from corrosive resistant stainless steel and house preferably two or more aerators in parallel. When air is fed to the aerators, they will emit a constant and uniform dispersion of air bubbles. This air rising from beneath the water not only aerates and mixes the water but also breaks up FOG at the surface. The special apparatus design also creates a vortex motion between the air flows creating more mixing and turbulence in the water to better break up the FOG and mix the body of water.

In a preferred embodiment, a submersible pump station aerating mixer is disclosed. The submersible pump station aerating mixer comprises of a frame that has a first plate and a second plate connected by at least two parallel frame tubes. The frame has a weight that overcomes a buoyancy of at least two aerators when fed with air. The frame is preferably made of stainless steel or any other metal. The aerators are positioned in parallel either above or below the frame tubes and are secured to the first plate by first locking plates and to the second plate by additional locking plates. The aerating mixer frame also has anchor shackles attached to the first and second plates. Each anchor shackle is attached to a hoisting system, wherein the hoisting system is used to raise or lower the aerating mixer.

In this preferred embodiment, an above ground compressor pumps air through an air-line to the aerators. The pumped air causes the aerators to emit streams of constant and uniform dispersion of air bubbles, wherein the rising air bubbles from the aerators creates a vortex motion between the streams.

In a preferred embodiment, the locking plates allows for the adjustment of the position of the aerators to maximize the creation of a vortex.

Furthermore, in an embodiment, each aerator comprises of an internal plastic tube with coarse perforations for the air to escape in a uniform pattern forming coarse bubbles. In another embodiment, the internal plastic tube is wrapped in an outer permeable layer that transforms the coarse bubbles into fine bubbles. The inner tube and outer layer are capped which seals off air from escaping and which provides a mechanism to feed air into the aerators.

In other embodiments, the aerating mixer further comprises a floatation device partway up the chain system such that as water level rises and falls in a wet well, a distance between aerator and surface in the water stays constant. Alternatively, the unit may include a winch system that raises and lowers the unit automatically.

Also disclosed is a preferred method of using the aerating mixer to break up fats, oils and grease in a sump. This method submerses an aerating mixer in the sump, wherein the aerating mixer has at least two aerators positioned in parallel. Air is pumped by an above ground compressor though an air-line to the aerators that causes the aerating mixer to emit streams of constant and uniform dispersion of air bubbles. The rising dispersion of air bubbles from the aerators creates a vortex motion between the streams.

In the preferred method, debris and fibrous materials is deterred from blocking the aerators by constructing the aerating mixer with at least two parallel frame tubes either above or below the aerators.

Additional embodiments increase the oxygen transfer to the water by wrapping an internal tube with coarse perforations with an outer permeable layer with finer perforations.

Other embodiment attach a floatation device to a chain system connected to the aerating mixer, wherein the floatation device rises and falls as water level rises and falls in the sump keeping a constant distance between the aerator mixer and a water surface.

In certain embodiments, aeration and oxygen transfer is increased by the aerator mixer emitting finer bubbles by positioning the aerators above the frame tubes. Alternatively, mixing of the water may be increased by positioning the aerators below the frame tubes allowing for coalescing of the fine bubbles into larger bubbles with greater mixing potential.

In another embodiment, a method to reduce hydrogen sulfide in a sump is disclosed. Tis method places an aerating mixer submersed in the sump, wherein the aerating mixer has at least two aerators positioned in parallel. Air is pumped by an above ground compressor though an air-line to the aerators. The aerators emit streams of constant and uniform dispersion of air bubbles creating a vortex motion between the streams.

### BRIEF DESCRIPTION OF THE DRAWINGS

Various embodiments are illustrated by way of examples in the figures of the accompanying drawings. Such embodiments are demonstrative and not intended to be exhaustive or exclusive embodiments of the present subject matter. The drawings are not necessarily to scale, emphasis instead being placed on illustrating the principals of the invention.

FIG. 1 is an isometric view of an aerating mixer in a preferred embodiment.

FIG. 2 depicts a side view of an aerating mixer with a sectional cut out view next to the side view in a preferred embodiment.

FIG. 3 depicts an end view of an aerating mixer in a preferred embodiment.

FIG. 4 depicts a bottom view of an aerating mixer in a preferred embodiment.

FIG. 5 depicts the aerating mixer breaking up FOG on a water surface.

### DETAILED DESCRIPTION OF THE INVENTION

The description that follows includes compositions, systems, methods, and apparatuses that embody various elements of the present disclosure. However, it should be understood that the described disclosure may be practiced in a variety of forms in addition to those described herein. Accordingly, the referenced drawings show, by way of illustration, specific embodiments in which the invention may be practiced. It is to be understood that other embodiments may be utilized, and structural changes may be made without departing from the scope of the claims. It is further understood that the steps described with respect to the disclosed processes may be performed in differing order and are not limited to the steps presented herein. Accordingly, other implementations describing object sizing, processes, elements, parts or mechanisms can be used and still be within the scope of the claimed invention.

In the preferred embodiments described herein, methods and apparatuses are disclosed that create a vortex motion between the air flows of at least two parallel aerators which causes more mixing and turbulence in the water in order to better break up the FOG and mix the body of water.

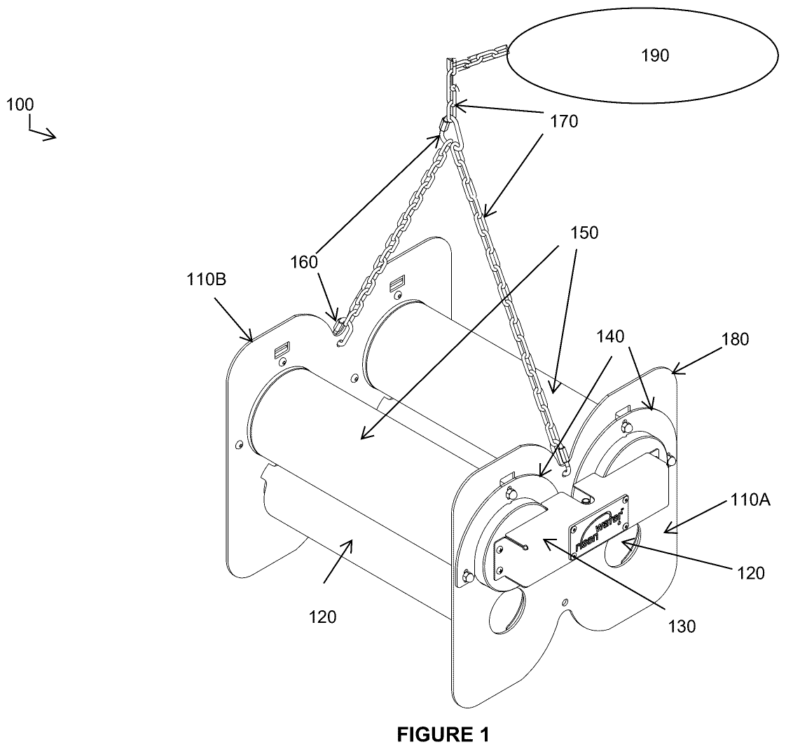

Referring to FIG. 1, illustrated is an isometric view of an aerating mixer 100 in the preferred embodiment. The submersible pump station aerating mixer 100 comprises of a frame 180 that has a first plate 110A and a second plate 110B connected by at least two parallel frame tubes 120, wherein the frame 180 has a weight that overcomes a buoyancy of at least two aerators 150 when fed with air. A cover plate 130 protects the tubing and fittings to the aerators 150. The frame 180 is preferably made of stainless steel or any other metal. The frame 180 is constructed to deter rags and fibrous materials from wrapping around the aerators 150 by the long sections of frame tube pipes 120. Preferably, the frame 160 has an effective length approximately 15 inches between the end plates 110A and 110B, but many other dimensions also may be used.

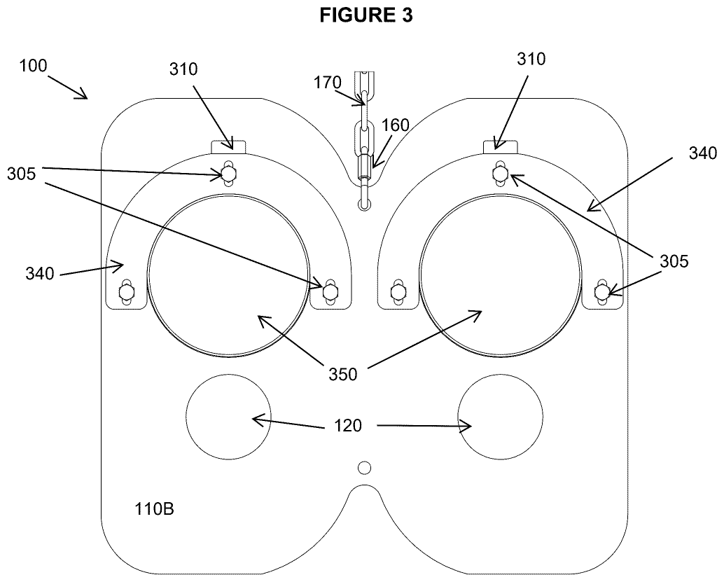

The aerators 150 are positioned in parallel either above or below the frame tubes 120 and are secured to the first plate 110A by first locking plates 140 and to the second plate 110B by additional locking plates 340 shown on FIG. 3. The locking plates 140, 340 are a simple way to clamp the aerators 150 in place while allowing for easy replacement and adjustment to the position of the aerators 150. The aerating mixer frame 180 also has anchor shackles 160 attached to the first 110A and second plates 110B. Each anchor shackle 160 is attached to a hoisting system 170, wherein the hoisting system 170, such as a winch system, can be used to raise or lower the aerating mixer 100. Alternatively, the aerating mixer 100 may comprise a floatation device 190 partway up the chain system 170 such that as water level rises and falls in a wet well, a distance between mixing aerator 100 and surface in the water stays constant.

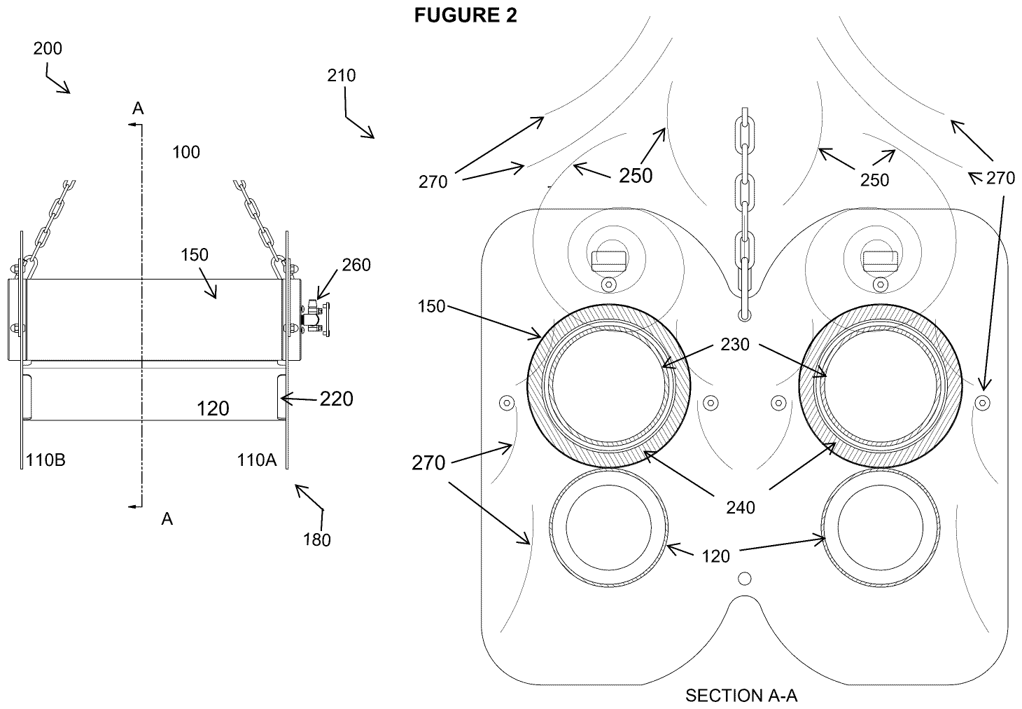

Referring to FIG. 2, illustrated are a side view 200 of an aerating mixer 100 in a preferred embodiment next to a cutout view 210 of section A-A. When air is fed to the aerators 150 through an air inlet nozzle 260, the aerators 150 will emit a constant and uniform dispersion of air bubbles 270. This air rising from beneath the water not only aerates and mixes the water but also breaks up FOG at the surface. The parallel aerators 150 are placed to ensure that the air bubbles 270 create a vortex 250 motion between them that creates more mixing and turbulence in the water to better break up the FOG and mix the body of water.

The aerator assembly 100 uses tubular aerators 150, which in one embodiment involves an internal plastic tube 230 with coarse perforations for the air to escape in a uniform pattern. The internal pipe 230 is then wrapped in an outer permeable layer 240 that takes the coarser bubbles from the internal tube 230 and turns them into fine bubbles 270. With finer bubbles 270, the amount of oxygen transfer to the water can increase, while coarse bubbles can offer enhanced mixing.

As previously stated, the frame 180 has a first plate 100A and a second plate 100B connected by at least two parallel frame tubes 120. The parallel frame tubes 120 have frame tube cut outs 220 at the ends of the tubes 120 to allow for better water drainage.

Referring to FIG. 3, illustrated is an end view of the aerating mixer 100 a preferred embodiment. Shown is an end plate 110B with an anchor shackle 160 attached to a chain 170 that is used to hoist the aerator assembly 100. The end plate 110B is preferably about 15 inches in width and slightly over 12 inches tall. The end plates 110A, 110B have end plate cut outs 310 to reduce water drag when moving the apparatus 100.

The aerators 150 are positioned in parallel either above or below the frame tubes 120 and are secured to the end plate 110B by the additional locking plates 340 as shown. The locking plates 340 are a simple way to clamp the aerators 150 in place via screws 305 while allowing for easy replacement and adjustment to the position of the aerators 150. The aerators 150 are capped with rear end caps 350 that seal off air from escaping out of the back ends.

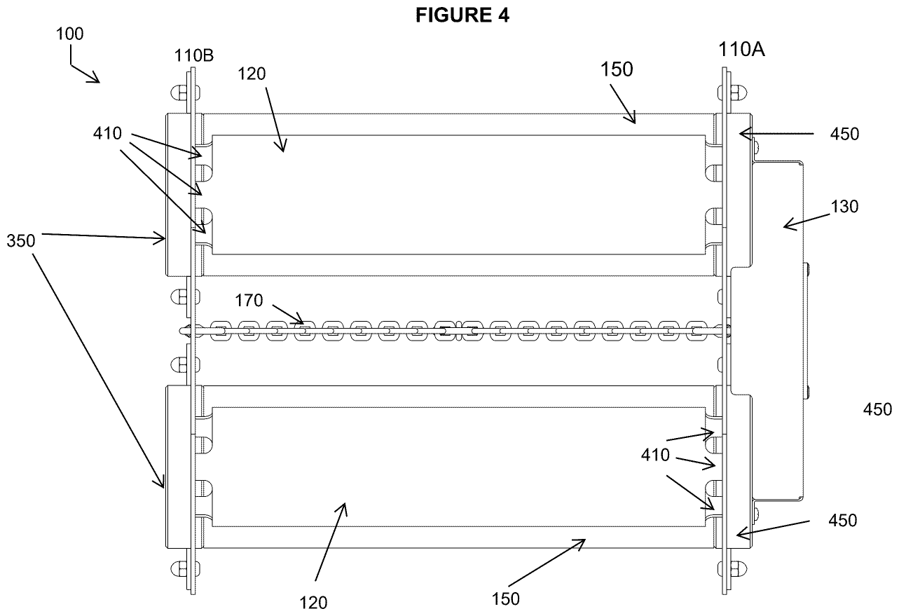

Turning now to FIG. 4, depicted is a bottom view of an aerating mixer 100 in a preferred embodiment. The parallel frame tubes 120 are welded to end plates 110A, 110B by frame tube attachment extensions 410. The aerators are capped with rear ends caps 350 and front end caps 450 that seal off air from escaping, while the front end caps 450 also have provisions to feed air into the aerators 150. A cover plate 130 protects the tubing and fittings that feed the air to the aerators 150. The aerator assembly 100 is lifted and submersed into position by a hoisting system 170.

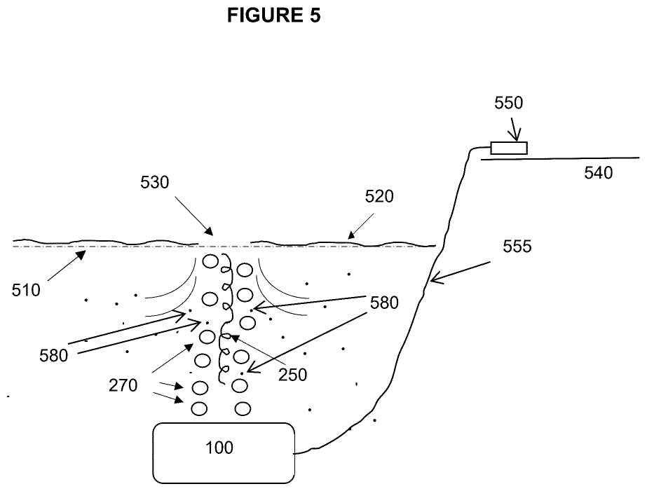

FIG. 5 depicts a submersed aerating mixer 100 breaking up FOG 520 on a water surface 510. Air is fed to the aerating mixer 100 from an air compressor pump 550 located above the water line 510 via an in-line air tube 555. The aerating assembly 100 emits a constant and uniform dispersion of air bubbles 270. This air bubbles 270 rising from beneath the water not only aerates and mixes the water but also breaks up FOG 520 at the surface. The submersed aerating apparatus 100 creates a vortex 250 motion between the air bubble streams 270 that will create more mixing and turbulence in the water. This vortex breaks up and leave larger and more openings 530 in the FOG 520. In addition, the small bubbles 270 acts as an oxidizing agent as sulfur dioxide H₂S 580 molecules and H₂O exchange protons rapidly. This reduction oxidation process dramatical reduces the amount of hydrogen sulfide 580 in the water. Once removed from the water and goes into the air, odor control systems can handle the gases.

1. A submersible pump station aerating mixer comprising:
a frame comprising a first plate and a second plate connected by at least two parallel frame tubes, wherein the frame has a weight that overcomes a buoyancy of at least two aerators when fed with air;
the aerators positioned in parallel either above or below the frame tubes, wherein the aerators are secured to the first plate by first locking plates and to the second plate by additional locking plates;
an above ground compressor that pumps air through an air-line to the aerators;
the aerators emit streams of constant and uniform dispersion of air bubbles when fed by air, wherein the rising dispersion of air bubbles from the aerators creates a vortex motion between the streams; and
anchor shackles attached to the first and second plates, wherein each anchor shackle is attached to a hoisting system, wherein the hoisting system is used to raise or lower the aerating mixer.

2. The aerating mixer of claim 1, wherein the frame is made of stainless steel or any other metal.

3. The aerating mixer of claim 1, wherein the locking plates allows for the adjustment of the position of the aerators.

4. The aerating mixer of claim 1, wherein each aerator comprises of an internal plastic tube with coarse perforations for the air to escape in a uniform pattern forming coarse bubbles.

5. The aerating mixer of claim 4, wherein the internal plastic tube is wrapped in an outer permeable layer that transforms the coarse bubbles into fine bubbles.

6. The aerating mixer of claim 1, wherein the inner tube and outer layer are capped which seals off air from escaping and provides a mechanism to feed air into the aerators.

7. The aerating mixer of claim 1, further comprises a floatation device partway up the chain system wherein as water level rises and falls in a wet well, a distance between aerator and surface in the water stays constant.

8. The aerating mixer of claim 1, further comprises a winch system that raises and lowers the unit automatically.

9. The method of claim 1, wherein the aerators are positioned above the frame tubes.

10. The method of claim 1, wherein the aerators are positioned below the frame tubes.

11. A method to break up fats, oils and grease in a sump, comprising:
placing an aerating mixer submersed in the sump, wherein the aerating mixer has at least two aerators positioned in parallel;
pumping air by an above ground compressor though an air-line to the aerators;
emitting streams of constant and uniform dispersion of air bubbles by the aerators when fed by the air, wherein the rising dispersion of air bubbles from the aerators creates a vortex motion between the streams.

12. The method of claim 11, further comprising deterring debris and fibrous materials from blocking the aerators by constructing the aerating mixer with at least two parallel frame tubes either above or below the aerators.

13. The method of claim 11, further comprising increasing the oxygen transfer to the water by turning coarse bubbles created by the aerators into finer bubbles by wrapping an internal tube with coarse perforations with an outer permeable layer with finer perforations.

14. The method of claim 11, further comprising attaching a floatation device to a chain system connected to the aerating mixer, wherein the floatation device rises and falls as water level rises and falls in the sump keeping a constant distance between the aerator mixer and a water surface.

15. The method of claim 12, further comprising increasing aeration and oxygen transfer by the aerator mixer emitting finer bubbles by positioning the aerators above the frame tubes.

16. The method of claim 12, further comprising increasing the mixing of the water by positioning the aerators below the frame tubes allowing for coalescing of the fine bubbles into larger bubbles with greater mixing potential.

17. The method of claim 12, wherein the fine bubbles and the vortex motion reduces hydrogen sulfide in the sump.

18. A method to reduce hydrogen sulfide in a sump, comprising:
placing an aerating mixer submersed in the sump, wherein the aerating mixer has at least two aerators positioned in parallel;
pumping air by an above ground compressor though an air-line to the aerators;
emitting streams of constant and uniform dispersion of air bubbles by the aerators when fed by the air, wherein the rising dispersion of air bubbles from the aerators creates a vortex motion between the streams.

19. The method of claim 18, further comprising increasing the oxygen transfer to the water by turning coarse bubbles created by the aerators into finer bubbles by wrapping an internal tube with coarse perforations with an outer permeable layer with finer perforations.

20. The method of claim 18, further comprising increasing aeration and oxygen transfer by the aerator mixer emitting finer bubbles by positioning the aerators above the frame tubes.
